(19) United States
(12) Patent Application Publication
(10) Pub. No.: US 2026/0017466 A1
(43) Pub. Date: Jan. 15, 2026

(54) INFORMATION PROCESSING SYSTEM, INFORMATION PROCESSING METHOD, AND NON-TRANSITORY COMPUTER-READABLE MEDIUM STORING PROGRAM

(71) Applicant: Rakuten Group, Inc., Tokyo (JP)

(72) Inventor: Anay BADAVNE, Tokyo (JP)

(73) Assignee: Rakuten Group, Inc., Tokyo (JP)

(21) Appl. No.: 19/262,228

(22) Filed: Jul. 8, 2025

(30) Foreign Application Priority Data
Jul. 12, 2024 (JP) 2024-112580

(51) Int. Cl. G06F 40/40

(52) U.S. Cl. CPC G06F 40/40

(57) ABSTRACT

An information processing method executed by one or more processors includes inputting a prompt into a machine learning generation model configured to output, when receiving an instruction for generating data. The prompt includes one initial draft of a notification text to be sent to one or more user terminals and includes a modification instruction for modifying the one initial draft. The information processing method includes acquiring a revised draft obtained by the generation model by modifying the one initial draft in accordance with the modification instruction. The information processing method includes inputting the revised draft into a machine learning prediction model configured to output, when receiving the revised draft, a prediction result for an index indicating response from a user in a case in which the revised draft has been received. The information processing method includes acquiring the prediction result that has been output by the prediction model.

### CROSS-REFERENCE TO RELATED APPLICATIONS

This application is based upon and claims the benefit of priority from Japanese Patent Application No. 2024-112580, filed on Jul. 12, 2024, the entire contents of which are incorporated herein by reference.

### BACKGROUND

### 1. Field

The present disclosure relates to an information processing system, an information processing method, and a non-transitory computer-readable medium storing a program.

### 2. Description of Related Art

In recent years, it has been proposed to use machine learning models for generating advertising texts used in advertisements. Japanese Laid-Open Patent Publication No. 2023-182309 discloses an example of a method for generating a machine learning model for generating advertising texts by fine-tuning an open-source pre-trained model. This machine learning model is trained to use a first advertising text, which has a click-through rate (CTR) greater than or equal to a predetermined value, as training data to output a second advertising text, which is expected to have a relatively high CTR.

While the use of machine learning models is not limited to the generation of advertising texts and has been applied in various fields, there remains significant room for improvement in how these models are utilized. It is an objective of the present disclosure to provide an information processing system, an information processing method, and a non-transitory computer-readable medium storing a program that enable the use of a machine learning model with a further improved approach.

### SUMMARY

This Summary is provided to introduce a selection of concepts in a simplified form that are further described below in the Detailed Description. This Summary is not intended to identify key characteristics or essential characteristics of the claimed subject matter, nor is it intended to be used as an aid in determining the scope of the claimed subject matter.

An information processing system according to an aspect of the present disclosure includes one or more memories configured to store program code and one or more processors. The one or more processors are configured to read the program code and operate as instructed by the program code. The program code includes prompt code configured to cause at least one of the one or more processors to input a prompt into a generation model for machine learning. The generation model is configured to output, when receiving an instruction for generating data, the data generated in accordance with the instruction. The prompt includes one initial draft of a notification text to be sent to one or more user terminals and includes a modification instruction for modifying the one initial draft. The program code includes revision code configured to cause the at least one of the one or more processors to acquire, from the generation model, at least one revised draft obtained by the generation model by modifying the one initial draft in accordance with the modification instruction. The program code includes prediction code configured to cause the at least one of the one or more processors to input the at least one revised draft into a prediction model for machine learning. The prediction model is configured to output, when receiving the at least one revised draft, a prediction result for at least one index indicating response from a user in a case in which a corresponding revised draft has been received. The program code includes result code configured to cause the at least one of the one or more processors to acquire the prediction result that has been output by the prediction model.

An information processing method according to an aspect of the present disclosure is executed by one or more processors. The information processing method includes inputting a prompt into a generation model for machine learning. The generation model is configured to output, when receiving an instruction for generating data, the data generated in accordance with the instruction. The prompt includes one initial draft of a notification text to be sent to one or more user terminals and includes a modification instruction for modifying the one initial draft. The information processing method includes acquiring, from the generation model, at least one revised draft obtained by the generation model by modifying the one initial draft in accordance with the modification instruction. The information processing method includes inputting the at least one revised draft into a prediction model for machine learning. The prediction model is configured to output, when receiving the at least one revised draft, a prediction result for at least one index indicating response from a user in a case in which a corresponding revised draft has been received. The information processing method includes acquiring the prediction result that has been output by the prediction model.

A non-transitory computer-readable medium according to an aspect of the present disclosure stores a program. The program includes prompt code configured to cause at least one of the one or more processors to input a prompt into a generation model for machine learning. The generation model is configured to output, when receiving an instruction for generating data, the data generated in accordance with the instruction. The prompt includes one initial draft of a notification text to be sent to one or more user terminals and includes a modification instruction for modifying the one initial draft. The program includes revision code configured to cause the at least one of the one or more processors to acquire, from the generation model, at least one revised draft obtained by the generation model by modifying the one initial draft in accordance with the modification instruction. The program includes prediction code configured to cause the at least one of the one or more processors to input the at least one revised draft into a prediction model for machine learning. The prediction model is configured to output, when receiving the at least one revised draft, a prediction result for at least one index indicating response from a user in a case in which a corresponding revised draft has been received. The program includes result code configured to cause at least one of the one or more processors to acquire the prediction result that has been output by the prediction model.

Other features and aspects will be apparent from the following detailed description, the drawings, and the claims.

### BRIEF DESCRIPTION OF DRAWINGS

FIG. 1 is a schematic diagram of an information processing system according to an embodiment.

FIG. 2 is an illustration showing an announcement screen displayed on the user terminal.

FIG. 3 is an illustration showing a notification display screen displayed on the user terminal.

FIG. 4 is an illustration showing an operation screen displayed during the generation of a notification by a notification generating application.

FIG. 5 is an illustration showing an operation screen displayed during the management of notifications by the notification generating application of FIG. 4.

FIG. 6 is an illustration showing a detail screen that has transitioned from the operation screen of FIG. 5.

FIG. 7 is an illustration showing how to generate a revised draft of a notification text.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

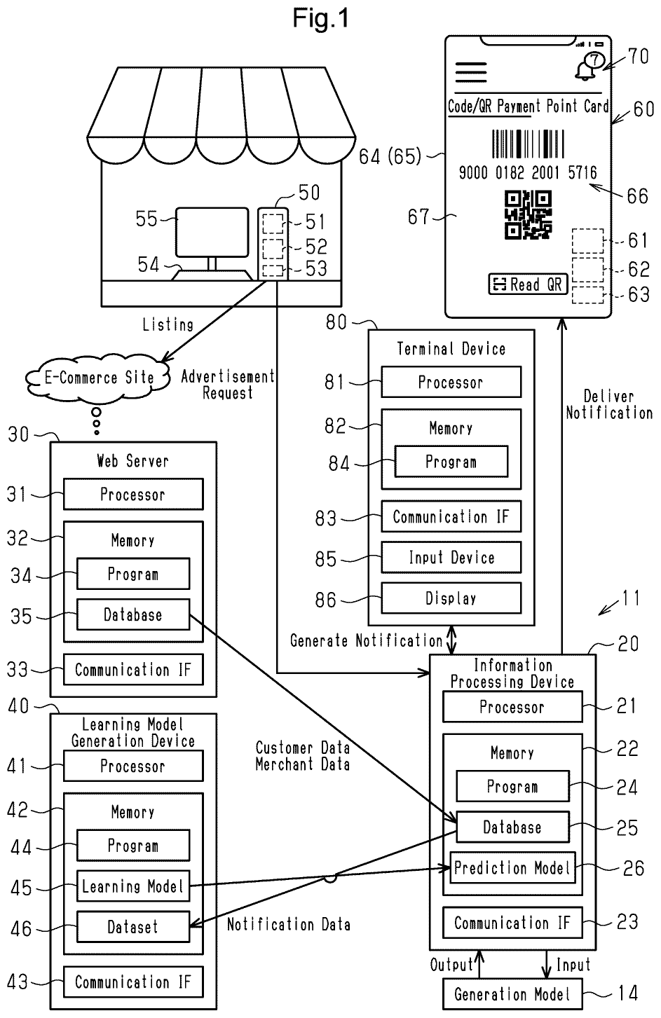

An information processing system 11, an information processing method, and a non-transitory computer-readable medium storing a program according to the present disclosure will now be described with reference to FIGS. 1 to 7. The scope of the present disclosure is defined not by the detailed description but by the claims and their equivalents, and all variations within the scope of the claims and their equivalents are to be construed as being included in the disclosure.

### Information Processing System

As shown in FIG. 1, the information processing system 11 includes an information processing device 20 that sends various notifications to a user terminal 60 used by a user. The information processing device 20 is operated by a notification sender. The notification sent from the information processing device 20 is received by one or more (normally, multiple) user terminals 60. Each user views notifications via an application (hereinafter sometimes simply referred to as an app) installed on the user terminal 60 used by the user.

The notification is presented to the user as “announcement”. The notification includes a notification text. The notification text includes information such as special offers, information related to new features or updates of the application, or store announcements. The special offers include campaign information from an administrator of the information processing device 20. The store announcements include advertisements requested by advertisers. The administrator of the information processing device 20 may be a provider of the app used to receive a notification.

The requester of the advertisement (i.e., the advertiser) may be, for example, a merchant that offers goods or services at a store. The store may be a physical store that conducts face-to-face sales, or an online store operating on an e-commerce (EC) site. The requester operates a requester terminal 50 to send the initial draft of an advertisement to the information processing device 20.

Based on the initial draft of the advertisement received from the requester terminal 50, the information processing device 20 executes information processing to generate a notification. Specifically, based on the initial draft of the notification text (e.g., advertisement) received from the requester terminal 50, the information processing device 20 uses a generation model 14 to generate a revised draft of the notification text. Then, based on the revised draft of the notification text, the information processing device 20 generates a notification that is to be sent to the user terminal 60.

The generation model 14 is configured to output, when receiving an instruction for causing the generation model to generate data, the data generated in accordance with the instruction. The initial draft of the notification text is not limited to an advertisement draft received from the requester terminal 50. Instead, the initial draft of the notification text may be, for example, an advertisement draft created by a contractor commissioned to produce the advertisement, or a notification draft created by the administrator.

The generation model 14 may be a language model configured to edit or generate a text. The language model may be a model for natural language processing trained using a large amount of text data. The generation model 14 is a general-purpose large-scale language model that can be adapted to perform natural language processing tasks (e.g., information extraction, text summarization, text generation, and question answering). The language model is configured to generate a text in response to a prompt that includes an instruction text to output the text as a completion.

In the present disclosure, the generation model 14 is a general-purpose language model in which the information processing device 20 is not included in the information processing system 11. Instead, the information processing device 20 may include the generation model 14. Alternatively, the information processing system 11 may include a computer that stores the generation model 14.

The general-purpose language model can generate a text in accordance with a given instruction; however, it is not necessarily clear whether the generated text is appropriate. For example, in the case of an advertising text, if the response from users who have read the advertising text is favorable, the advertisement is effective and appropriate. An index that reflects the response from users or the effectiveness of the advertisement (hereinafter simply referred to as an advertisement index) may be, for example, a click-through rate (CTR) for a link included in the advertising text. The index may be user engagement, which represents the degree of user participation or interaction with respect to the advertisement (notification), but is not limited thereto.

The information processing system 11 includes a prediction model 26 that predicts an index value for a notification text. For example, the prediction model 26 is configured to output, when receiving one notification text example, a prediction result for an index indicating response from a user in a case in which the notification text example has been received.

After acquiring the initial draft of a notification text, the information processing device 20 causes the generation model 14 to generate a revised draft, which is obtained by modifying the initial draft. Further, the information processing device 20 inputs the revised draft to the prediction model 26 and acquires a prediction value of the index as a prediction result from the prediction model 26. The index is not limited to a click-through rate, and may be, for example, a view rate (display rate) of a delivered notification, gross merchandise sales (GMS), the number of installations or the number of launches of the advertised app, or the number of views of a linked video.

The information processing system 11 may include at least one server 30. The at least one server 30 may include one or more of a web server that provides an e-commerce site, a processing server that provides electronic payment services, and a management server that provides a point program. In this example, the information processing system 11 includes one web server that provides an e-commerce site.

The information processing system 11 may include a learning model generation device 40. The learning model generation device 40 is configured to generate a prediction model 26. When the information processing system 11 (the information processing device 20 in this example) includes multiple prediction models 26, the information processing system 11 may include multiple learning model generation devices 40 that respectively generate the prediction models 26. In this example, the information processing system 11 includes one learning model generation device 40 that generates a prediction model 26 to predict a click-through rate.

### Requester Terminal

The requester terminal 50 used by a requester may be implemented as a computer that includes at least one processor 51, at least one memory 52, and a communication interface (IF) 53. To facilitate understanding, the requester terminal 50 includes one processor 51 and one memory 52. The requester terminal 50 may be a mobile terminal, such as a smartphone or a tablet.

The communication IF 53 enables communication with other devices via a network. The requester terminal 50 may include an input device 54 and an output device 55. Instead, these devices may be externally connected to the requester terminal 50. The input device 54 may include, for example, a keyboard and a mouse. The output device 55 may be, for example, a display. The requester terminal 50 may include a touch panel, which serves as an input-output device.

The requester may, for example, prepare an initial draft of an advertisement for a physical store or an online store. The content and format of the advertisement may be defined by a notification sender. For instance, the format of an advertisement delivered to a user via a notification may include a title as a header, a body text, an image, and a link. The image disclosed in the present disclosure is a header image displayed along with the title. Instead, the image may be an image included in the body text or may be an advertisement image that replaces the body text. The link is included in at least one of the title, the body text, or the image.

### User Terminal

The user terminal 60 may be implemented as a computer that includes at least one processor 61, at least one memory 62, and a communication IF 63. To facilitate understanding, the user terminal 60 includes one processor 61 and one memory 62. The communication IF 63 enables communication with other devices via a network.

The user terminal 60 may be, for example, a mobile terminal such as a smartphone or a tablet. The user terminal 60 may include a display 64, which serves as an output device. The display 64 may include a touch panel, which serves as an input device.

The memory 62 stores various types of programs and data executed by the processor 61. The program includes an application for receiving a notification from the information processing device 20. The processor 61 performs various functions by executing processes in accordance with the programs.

The application for receiving notifications may be, for example, an electronic payment application for conducting electronic payments such as code-based payments (hereinafter referred to as a pay app), a point management application for managing points, or a shopping application for using an e-commerce site. Notifications are generated in a format to be displayed on an application installed on the user terminal 60. Hereinafter, the example in which notifications are received via the pay app installed on the user terminal 60 will be described.

The pay app may display, for example, a notification link button 70, which notifies the user that there is a notification, on the header of a payment screen 67, which displays a code 66 for payment. The notification link button 70 may be an icon or a character. The display of the notification link button 70 allows users to recognize that a new notification has been delivered or that there is an unread notification. For example, in FIG. 1, a numerical value displayed within a badge superimposed on the notification link button 70 (bell icon) indicates the number of unread notifications. The user operates the notification link button 70 to view the content of a delivered notification.

### Web Server

The server 30, which provides an e-commerce site, may be implemented as a computer that includes at least one processor 31, at least one memory 32, and a communication IF 33. To facilitate understanding, the server 30 includes one processor 31 and one memory 32. The communication IF 33 enables communication with other devices via a network.

The memory 32 stores a program 34 and a database 35 executed by the processor 31. The program 34 includes an application and an operating system. The processor 31 performs various functions by executing processes in accordance with the program 34.

In this example, the server 30 provides a marketplace-style e-commerce site where multiple businesses or stores have storefronts. The e-commerce site may be an online store operated for a single business or a single store. In the e-commerce site, electronic payments may be enabled through processing performed by the server 30 or another server, and points of a point program may be granted based on the payment amount.

The database 35 may include merchant data. The merchant data may include multiple merchant records for each of multiple merchants. Examples of each merchant record may include, but are not limited to, a merchant ID as an identifier, a merchant name, a store name, a store ID, a store address, an account on an e-commerce site, an email address, authentication information, a payment receiving account, a store terminal ID, an electronic payment history, a sales history on the e-commerce site, and a point grant history, The store terminal may be a cashless payment terminal, or may be a point-of-sale (POS) register integrated with a payment terminal.

The merchant data may further include available products (or services), genres of the available products (or services), brands, and items. Examples of the genres include, but are not limited to, ladies' fashion, men's fashion, kids' and baby products, daily necessities, cosmetics, diet, health, home appliances, sports, outdoor goods, home and living, pet supplies, and hobbies. The genre may match the available genre on an e-commerce site.

The database 35 may include customer data related to customers who use an e-commerce site. The customer data may include, for example, multiple customer records for each of multiple customers, using a customer ID as an identifier. Examples of each customer record may include, but are not limited to, a name, an address, an account, an email address, an electronic payment history, a purchase history on an e-commerce site, a point accumulation history, and a point usage history. Examples of the payment history and the purchase history include, but are not limited to, a store name where the transaction was made, a date and time of the transaction, purchased items, genres of the purchased items, and a purchase amount.

### Information Processing Device

The information processing device 20 may be implemented as a computer that includes at least one processor 21, at least one memory 22, and a communication IF 23. To facilitate understanding, the information processing device 20 includes one processor 21 and one memory 22. The communication IF 23 enables communication with other devices via a network.

The memory 22 stores a program 24 and a database 25 that are executed by the processor 21. The program 24 includes an application and an operating system. The processor 21 performs various functions by executing processes in accordance with the program 24. The memory 22 may store the prediction model 26 generated by the learning model generation device 40.

The database 25 may include delivery destination data related to multiple users who are candidates for receiving notifications, requester data related to advertisement advertisers, and notification data related to notifications to be delivered. The information processing device 20 may acquire the data included in the server 30 via a network. The data item of the delivery destination data may match some or all of the customer data included in the database 35. The delivery destination data may include some or all of the customer data. The data items of the requester data may match some or all of the merchant data included in the database 35. The requester data may include some or all of the merchant data.

The notification data may include, for example, multiple notification records for each of multiple notifications, using a notification ID as a record identifier. Examples of each notification record include, but are not limited to, a requester name, a category, a title, a delivery start date and time, a delivery frequency, and a status. Examples of the category include, but are not limited to, special offers, information related to new features and updates of the app, and store announcements. Hereinafter, a notification that includes an advertisement among special offers and store announcements may be referred to as an advertising notification. Examples of the status include, but are not limited to, “Delivering”, “Draft”, “On Hold”, and “Completed”, all of which represent the delivery status.

The notification data may include, as a delivery log of the notification, a delivery destination, a delivery start date and time, and the number of deliveries. The notification data may further include actual result data regarding user engagement with delivered notifications. The actual result data may include, as user engagement with advertising notifications, at least one index representing advertising effectiveness, such as the number of impressions (i.e., the number of times the notification has been displayed), the number of clicks, and the click-through rate. The actual result data may also include the content of each notification, such as advertising content. The advertising content may include, for example, a title, a body text, a website link URL, and an image.

### Learning Model Generation Device

The information processing system 11 may include a learning model generation device 40 that generates a prediction model 26. The learning model generation device 40 may be implemented as a computer that includes at least one processor 41, at least one memory 42, and a communication IF 43. To facilitate understanding, the learning model generation device 40 includes one processor 41 and one memory 42. The communication IF 43 enables communication with other devices via a network.

The memory 42 stores a program 44 executed by the processor 41. The program 44 includes an application and an operating system. The processor 41 performs various functions by executing processes in accordance with the program 44. The memory 42 may store a learning model 45 generated by a dataset 46 for learning.

The dataset 46 may include notification data (particularly, delivery log and actual result data) obtained from the information processing device 20. The dataset 46 is not limited to notifications sent via the pay app, and may include delivery logs and actual result data of notifications sent via other apps (e.g., a point management app or a shopping app) or via email.

The dataset 46 may include training data, validation data, and test data. The dataset 46 may include the merchant data and customer data that have been acquired from the server 30. The learning model generation device 40 may edit the customer data so as to include user data for multiple user groups, each having a different attribute. The dataset 46 may include such edited user data.

For example, when a user to whom a notification is to be delivered matches a customer included in the customer data, the learning model generation device 40 may cluster multiple customers included in the customer data into multiple user groups based on one or more shared attributes possessed by each customer. Examples of the user attribute include, but are not limited to, residential area, age group, gender, and annual income.

The user group may be clustered in advance such that it can be subject to delivery of an advertising notification. One or more personas, which are fictional user characters, may be set to perform such clustering. The profile of a persona can be set by combining multiple attributes (e.g., a female in her 20s to 30s).

The learning model 45 may utilize, for example, an algorithm such as logistic regression or gradient boosting. The learning model 45 may be pre-trained. In this case, a trained model may be generated by performing transfer learning or fine-tuning on a pre-trained model using the dataset 46.

The learning model generation device 40 may train the learning model 45 so as to output a click-through rate as a prediction value when receiving an advertising text (at least one of a title or a body text) using advertisement actual result data as training data. The prediction model 26 used in this manner is configured to output, when receiving, for example, an advertising text of an initial draft, the click-through rate predicted from the advertising text. The learning model 45 may be re-trained regularly or irregularly based on additional actual result data.

The learning model generation device 40 may use the dataset 46 to train the learning model 45, thereby generating a trained model. The trained model generated in this manner is referred to as the prediction model 26. The prediction model 26 generated by the learning model generation device 40 is provided to the information processing device 20 and stored in the memory 22.

The prediction model 26 is configured to output a prediction result that corresponds to the attribute of a user (e.g., e-commerce site customer) after being trained using user data for multiple users that includes multiple attribute values for each of the users. When receiving one notification text example (a revised draft of a notification text) and the attribute of a user to whom a notification is delivered, the prediction model 26 outputs a prediction result that is based on the attribute of the user.

The learning model generation device 40 may use user data of a user group including one or more shared attributes to train the learning model 45, thereby generating a prediction model 26 that outputs a prediction result focusing on the user group. That is, the learning model generation device 40 may generate multiple prediction models 26 that respectively correspond to multiple user groups. In this case, the prediction result based on the user attribute is obtained by changing the prediction model 26 used depending on the attribute of the user to whom a notification is delivered.

### Terminal Device

An operator responsible for creating a notification text is able to create a revised draft of a notification text using a terminal device 80. Examples of the operator using the terminal device 80 may be, but are not limited to, a requester who creates an advertisement initial draft, a contractor commissioned to create an advertisement, a sender that delivers notifications, an administrator of the information processing device 20.

The terminal device 80 may be implemented as a computer that includes at least one processor 81, at least one memory 82, and a communication IF 83. To facilitate understanding, the terminal device 80 includes one processor 81 and one memory 82. The communication IF 83 enables communication with other devices via a network.

The memory 82 stores a program 84 executed by at least one processor 81. The program 84 includes one or more applications and an operating system. The processor 81 performs various functions by executing processes in accordance with the program 84.

The terminal device 80 may include an input device 85 and a display 86. Instead, these devices may be externally connected to the terminal device 80. The input device 85 may include, for example, a keyboard and a mouse. The terminal device 80 may include a touch panel, which serves as an input-output device.

The one or more applications stored in the memory 82 includes a notification generating application. Hereinafter, the notification generating application is referred to as a drafting tool. The operator uses the drafting tool to create a revised draft of a notification. In addition to the notification generating function to create a revised draft of a notification, the drafting tool may include a notification management function to manage the transmission of a notification.

### Notification Display in User Terminal

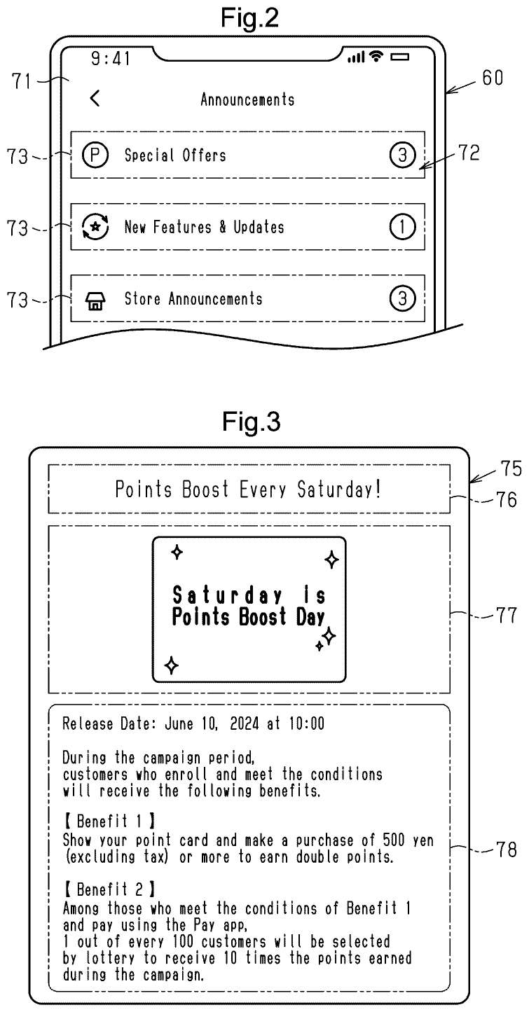

The notification link button 70 displayed on the user terminal 60, which is shown in FIG. 1, is operated to display an announcement screen 71, which is shown in FIG. 2. The announcement screen 71 may display a list of notifications or may display a category list 72 as illustrated in FIG. 2. The category list 72 may include multiple list elements 73 that indicate the category of a notification (special offers, new features and updates, and store announcements in FIG. 2).

The category list 72 may display the presence of new or unread notifications. For instance, in FIG. 2, the number of unread notifications are displayed at the right end of each list element 73. When one of the list elements 73 is selected, the announcement (notification) regarding the selected category is displayed.

FIG. 3 illustrates a notification display screen 75, which displays a notification. The notification display screen 75 includes, for example, a title box 76, which displays a title, an image area 77, which displays an image, and a body text box 78, which displays a body text. In the present disclosure, the image area 77 is displayed between the title and the body text.

### Drafting Tool

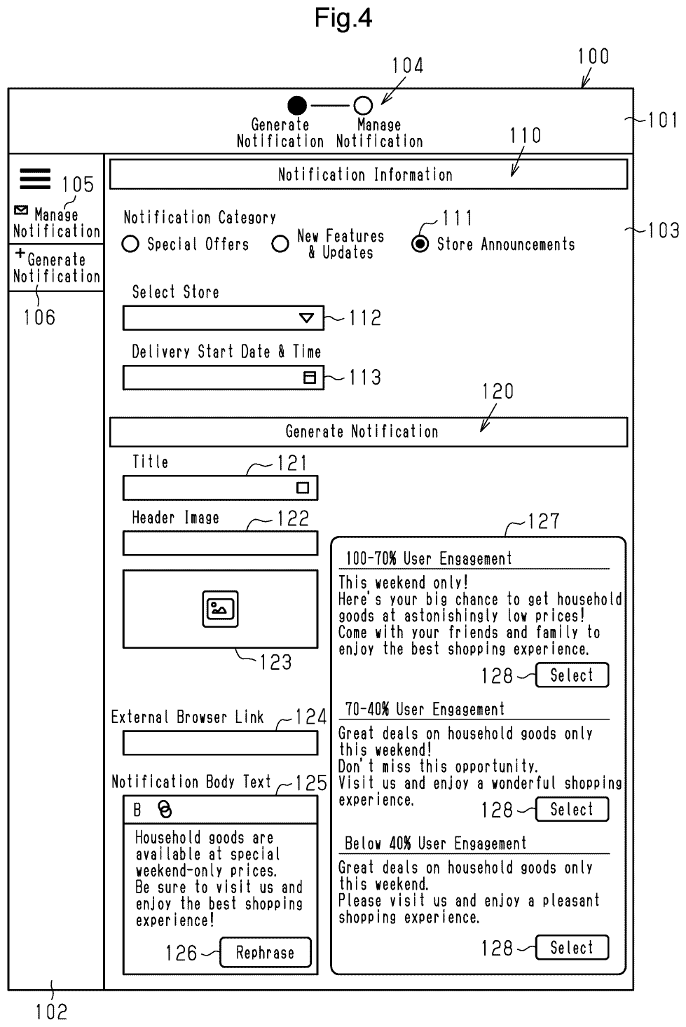

FIG. 4 illustrates an operation screen 100 displayed on a display 86 when the drafting tool is activated in the terminal device 80. The operation screen 100 is merely an example and may be modified to any other design. The operation screen 100 includes a navigation bar 101, a side bar 102, and a main column 103. The navigation bar 101 includes a tab 104 that displays switching between the notification generating function and the notification management function.

The side bar 102 may include, for example, a notification management button 105, which is operated to manage the delivery of notifications, and a notification generating button 106, which is operated to generate a notification. FIG. 4 illustrates the operation screen 100 when the notification generating button 106 is operated.

When the notification generating button 106 is operated, the main column 103 may display a notification information area 110, which indicates notification information, and a notification generating area 120, where a notification is generated. The notification information area 110 may include one or more category buttons 111 (three radio buttons in this example) to select a notification category.

When one of the category buttons 111 is selected, the notification information area 110 may display a selection column 112. For example, when the selection column 112 is operated with the category button 111 for the store announcements selected, a dropdown list of multiple stores (i.e., stores or merchants that have requested advertisements) may be displayed. The notification information area 110 may include a date-and-time input column 113, to which the date and time when the delivery of a notification starts is input. When the date-and-time input column 113 is operated, a date picker for inputting a date via a calendar and a time picker for setting a time may be displayed.

The notification generating area 120 may include a title input column 121, to which a title is input, and an image designation column 122, which designates an image (in this case, a header image). The notification generating area 120 may further include an image display column 123, which displays a designated image. The notification generating area 120 may further include a URL input column 124, to which a link that opens in an external browser included in a body text is input.

The notification generating area 120 includes a body text input column 125, to which a body text is input. When an operator inputs a text into the body text input column 125, the body text input column 125 or the notification generating area 120 may display a rephrase button 126. The rephrase button 126 is operated for the generation model 14 to generate one or more revised drafts, using the text input into the body text input column 125 as an initial draft. Regardless of whether a text has been input, the rephrase button 126 may be displayed in advance in the body text input column 125 or the notification generating area 120.

When the rephrase button 126 is operated, the terminal device 80 sends, to the information processing device 20, the initial draft input into the body text input column 125. Upon receiving the initial draft, the information processing device 20 sends, to the terminal device 80, the revised draft generated by the generation model 14 based on the initial draft. The information processing device 20 may send, to the terminal device 80, the revised draft and the prediction result (e.g., a prediction value of a click-through rate) of the prediction model 26 for the revised draft.

The information processing device 20 may send one revised draft for one initial draft to the terminal device 80 or may send multiple revised drafts for one initial draft to the terminal device 80. When sending multiple revised drafts to the terminal device 80, the information processing device 20 may send multiple prediction results for each of the revised drafts to the terminal device 80.

The notification generating area 120 may include a button (not shown) to designate the number of revised drafts to be generated or an input column (not shown) to which the number is input. In this case, the information processing device 20 sends a designated number of revised drafts for one initial draft and the corresponding number of prediction results to the terminal device 80.

When the rephrase button 126 is operated, the terminal device 80 displays a revised draft display column 127 in the notification generating area 120 and displays, in the revised draft display column 127, one or more revised drafts received from the information processing device 20. The terminal device 80 may display, in the revised draft display column 127, one or more revised drafts and the prediction results respectively corresponding to the revised drafts.

Regardless of whether the rephrase button 126 has been operated, the revised draft display column 127 may be displayed in advance in the notification generating area 120. When multiple revised drafts are displayed in the revised draft display column 127, select buttons 128 respectively corresponding to the revised drafts may be displayed in the revised draft display column 127.

When the terminal device 80 receives multiple revised drafts and the corresponding number of prediction results, the processor 81 may display one of the revised drafts that has the best prediction result in the revised draft display column 127. Alternatively, the processor 81 may display some of the revised drafts in the revised draft display column 127. For example, the processor 81 may display, in the revised draft display column 127, only one of the revised drafts that has a predicted advertisement index being greater than a specified target value (e.g., 60%, 70%, 80%, or 90%).

The prediction result for a revised draft may be displayed in the revised draft display column 127 as a classification based on predetermined numerical ranges (e.g., less than 40%, 40 to 70%, and 70 to 100%). The classification based on the predetermined numerical ranges may be set in consideration of, for example, the prediction accuracy of the prediction model 26. The prediction result may be displayed as an upper-concept index (e.g., user engagement), instead of the value of a specific index (e.g., a click-through rate).

When the operator operates the select button 128 to select one of one or more revised drafts, the selected revised draft is replaced with the initial draft, which has been previously input, and displayed in the body text input column 125. Thus, the select button 128 may be a replace button. Similarly, when the revised draft display column 127 displays only one revised draft, the operator operates the select button 128 to replace the initial draft with the revised draft, so that the revised draft is displayed the body text input column 125.

In this example, the initial draft of a body text is replaced with a revised draft, and the prediction result of the revised draft is displayed. In other examples, instead of or in addition to the body text, the initial draft of the title of an advertisement may be replaced with a revised draft, and the prediction result of the revised draft may be displayed.

The operator may further edit the revised draft that has been replaced with the initial draft. For example, when the body text includes notification items (e.g., the start date of a campaign related to the advertisement or conditions for obtaining benefits), such notification items do not need to be modified. Thus, the body text may be completed by inputting only a text that needs to be rephrased into the body text input column 125 in advance, replacing it with the revised draft as necessary, and then adding a notification item. In this manner, a notification text generated by the generation model 14 may be part of a body text (or a title).

The operation screen 100 may include one or more operation buttons (not shown) to select a target user to whom a notification is sent. For example, the one or more select buttons may include a button for selecting a predetermined user group or a button for designating an attribute of the user group to send a notification. The user group may be clustered in advance so as to match the prediction target of the prediction model 26. Examples of the attributes of the user group include, but are not limited to, the age group of the user (e.g., teens, 20s, or 30s), gender, and a region (e.g., prefecture).

The operation screen 100 may include a save button (not shown) to save the notification generated in the above-described manner and a cancel button (not shown) to end the processing without a notification. When the operator operates the save button, the content input and operated via the operation screen 100 is sent to the information processing device 20 through the network from the terminal device 80 as notification data. After receiving the sent notification data, the information processing device 20 may store the notification data in the memory 22 as part of the database 25.

The operation screen 100 may include a review button (not shown) to review the notification generated in the above-described manner. When the operator operates the review button, the full details of the notification, including the title, image, and body text, may be displayed in the main column 103 or another window as shown in FIG. 3.

The drafting tool may have a function (not shown) to send a revised draft of a notification delivered to the approver or requester of notification delivery to obtain approval for the delivery from the approver regarding the notification generated in the above-described manner. The delivery and approval of a revised draft may be achieved by the function of the drafting tool or the function of another communication application (e.g., an email client).

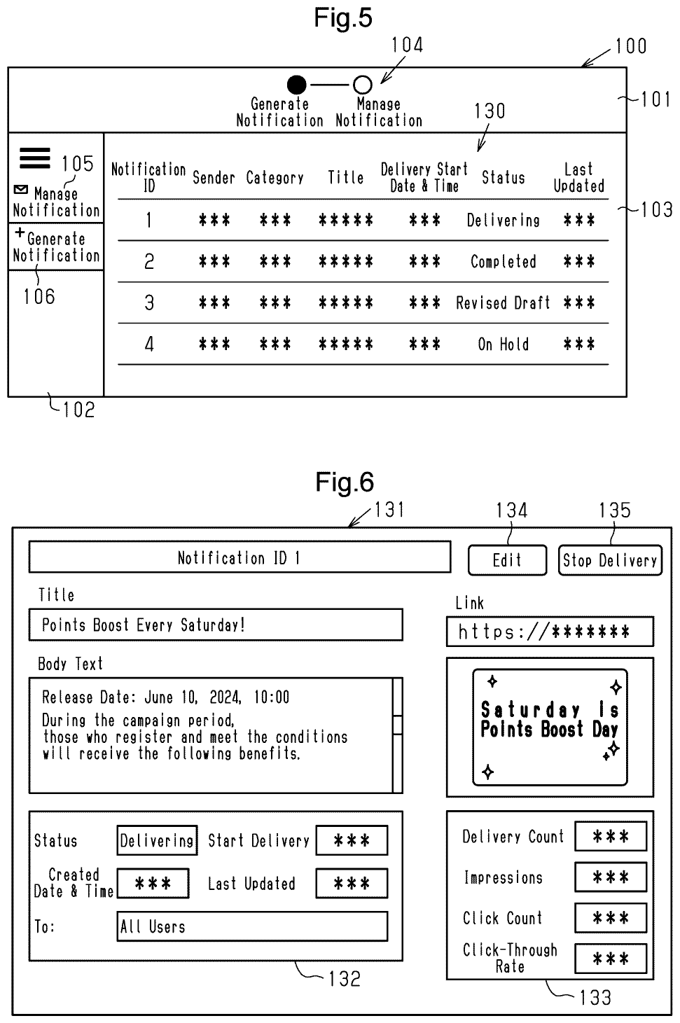

FIG. 5 illustrates the operation screen 100 when the notification management button 105 is operated. When the notification management button 105 is operated, the terminal device 80 requests, from the information processing device 20, notification data to be displayed on the operation screen 100. In accordance with the request from the terminal device 80, the information processing device 20 sends the notification data stored in the memory 22 to the terminal device 80. Upon receiving the notification data, the processor 81 of the terminal device 80 displays it as a notification list 130 in the main column 103.

The main column 103 may display multiple notification records for each of multiple notifications generated, using a notification ID as a record identifier. Examples of each notification record include, but are not limited to, the sender (e.g., the name of the store that requested the advertisement), category, title, delivery date and time (a scheduled delivery date and time if not yet delivered, or a delivery start date and time if already delivered), status, and last updated date and time.

While the notification is being generated or is pending approval, the status is set to “Revised Draft”. When the approver or the requester requests a change to the notification content (i.e., rejects the approval), the status is set to “On Hold”. The “Revised Draft” status is changed to “Pending Delivery” once approval is obtained. When the notification record displayed in the main column 103 is selected, its detailed information may be displayed in the main column 103 or another window.

FIG. 6 illustrates a detail screen 131 displaying the detailed information of a notification record. The detail screen 131 may include a detail column 132 displaying the delivery status in addition to the title, body text, link, and image of a notification. Examples of the displayed content of the detail column 132 may include, but are not limited to, the status, the date and time of generating a notification, the delivery start date and time, the last updated date and time, and a destination to which the notification is delivered.

The detail screen 131 for notification records in which the statuses are “Delivering” and “Completed” may include an actual result column 133. The actual result data may include, for example, actual result data for user engagement in addition to the cumulative delivery count. Examples of the actual result data may include, but are not limited to, the number of impressions (i.e., the number of times the notification has been displayed), the number of clicks, and the click-through rate. Regarding the number of impressions, for example, the notification may not be considered to have been displayed when the announcement screen 71 shown in FIG. 2 is presented, and may be considered to have been displayed when the notification display screen 75 shown in FIG. 3 is presented.

The detail screen 131 may include an edit button 134 and a delivery button 135. The delivery button 135 may be operated to stop delivery with a “Stop Delivery” indication when the status is “Delivering”. The delivery button 135 may be operated to start delivery with a “Start Delivery” indication when the status is “Pending Delivery”. When the operation to start delivery is performed in this manner, the information processing device 20 starts delivering a notification to the user terminal 60 set as a delivery target at the set delivery start date and time.

The edit button 134 is operated to edit a notification record. The operator operates the edit button 134 to display the operation screen 100 as shown in FIG. 4, thereby editing the notification record. For example, for a notification in which the status is “On Hold”, the operator can alter a revised draft to another one, as an editing task. Further, for a notification that is being delivered, when the intended level of user engagement is not achieved, the operator can re-deliver the notification after editing the advertising text.

### Method for Generating and Delivering Message

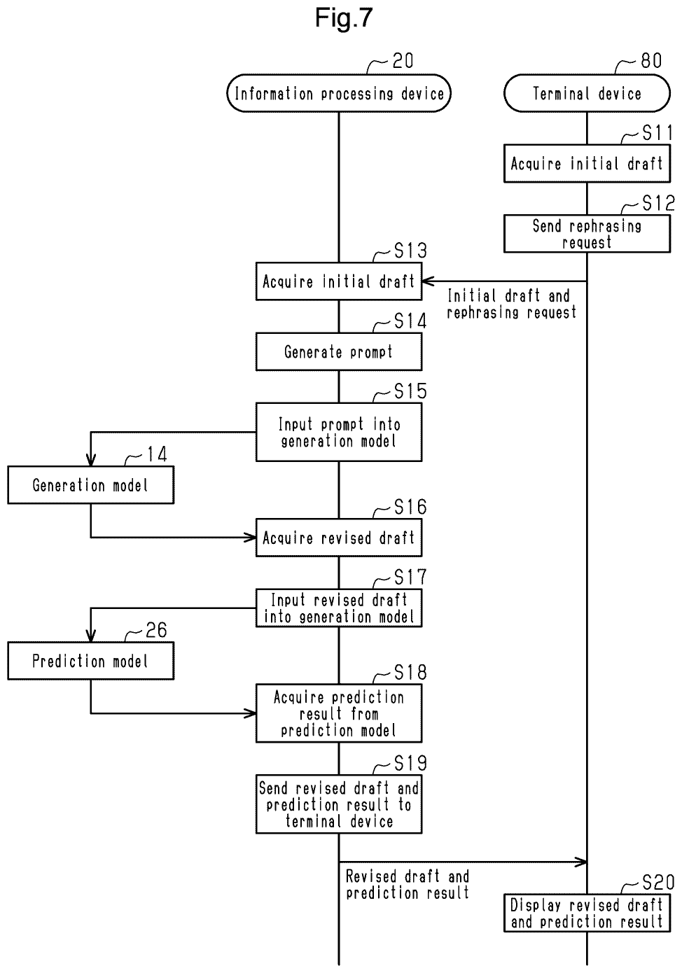

The information processing method of the present disclosure will now be described with reference to FIG. 7. Particularly, FIG. 7 illustrates a method for generating a revised draft of a notification text in the information processing method of the present disclosure. The processor 21 of the information processing device 20 and the processor 81 of the terminal device 80 operate together to execute various commands, thereby executing the information processing method. The commands for executing the information processing method are included in the program 24, which is stored in the memory 22, and the program 84, which is stored in the memory 82.

In step S11, the processor 81 acquires an initial draft of a notification text (e.g., an advertising text) that has been input into the body text input column 125 of the drafting tool by the operator. In step S12, when the operator operates the rephrase button 126, the processor 81 sends, to the information processing device 20, the initial draft input in step S11 and a rephrasing request.

In step S13, the processor 21 acquires the initial draft upon receiving the initial draft and the rephrasing request sent by the terminal device 80. In step S14, the processor 21 refers to the rephrasing request to generate a prompt that is to be input into the generation model 14.

At least part of the information used to generate the prompt may be included in the rephrasing request. For example, the rephrasing request may include the data input into the notification information area 110 (e.g., a notification category, the requester of an advertisement, or a delivery start date and time).

The prompt includes one initial draft of a notification text (the body text of an advertisement in this example) and a modification instruction for modifying the one initial draft. Instead, the modification instruction may include an instruction for generating multiple revised drafts for one initial draft. The prompt may be generated in advance before the process of FIG. 7 starts.

The modification instruction includes an instruction for modifying one initial draft so as to improve the value of an index (e.g., a click-through rate) to improve reaction from users, that is, to improve user engagement. The modification instruction may include, for example, an instruction for modifying one initial draft such that the value of the index approaches or exceeds a specified target value (e.g., 60%, 70%, 80%, or 90%). The modification instruction may include an instruction for a modification to simply improve the index value regardless of the target value.

The modification instruction may include targeted indices. One of the indices may be the same as a prediction index that is output by the prediction model 26. For example, when the advertisement index and the prediction index are click-through rates, the modification instruction may include multiple objectives. The objectives include a first objective of achieving a click-through rate of 70% or higher and a second objective of increasing the GMS of the target store.

When the notification text subject to rephrasing includes an advertising text for one store, the modification instruction may include supplementary information used to generate the advertising text. The supplementary information may include store information for an advertiser or one store subject to advertising. The one store may be affiliated with an electronic payment service or may be operating on an e-commerce site. In this case, the processor 21 may acquire the store information for the one store from the database 35 of the server 30. Examples of the store information may include, but are not limited to, available products (or services), genres of the available products (or services), brands, and items.

The modification instruction may include, as the supplementary information, at least some of the content of a campaign related to an advertisement, the period of a campaign, an app (e.g., a pay app) that displays a notification, or the attribute (e.g., age group, gender, or residential area) of a user who is to receive a notification. For example, the supplementary information may include information indicating that one store is affiliated with an electronic payment service and information indicating that the user who receives a notification uses the electronic payment service. The processor 21 may acquire such supplementary information from the notification data stored in the memory 22.

In step S15, the processor 21 inputs the generated prompt into the generation model 14. In step S16, the processor 21 acquires a completion that has been output by the generation model 14. The completion includes one or more revised drafts that are obtained by the generation model 14 by modifying one initial draft in accordance with the modification instruction. Thus, the processor 21 acquires one or more revised drafts in step S16.

In step S17, the processor 21 inputs the one or more revised drafts acquired in step S16 to the prediction model 26. In step S18, the processor 21 acquires the prediction result of an index for each of the one or more revised drafts output by the prediction model 26. When acquiring multiple revised drafts in step S16, the processor 21 inputs the revised drafts one by one into the prediction model 26 and acquires the corresponding prediction result, thereby acquiring the prediction results respectively corresponding to the revised drafts.

When the prediction model 26 is configured to output a prediction result that corresponds to a user attribute, the processor 21 may input, into the prediction model 26, a revised draft and the attribute of a user who is to receive a notification text. In this case, the processor 21 acquires the prediction result corresponding to the user attribute in step S18.

In step S19, the processor 21 sends, to the terminal device 80, one or more revised drafts generated by the generation model 14 and one or more corresponding prediction results output by the prediction model 26. When the terminal device 80 receives the revised drafts and the prediction results sent by the information processing device 20, the processor 81 displays the received revised drafts and prediction results in the revised draft display column 127 (i.e., on the display 86 of the terminal device 80).

### Operation of Present Disclosure

The revised draft display column 127 of the drafting tool displays one or more revised drafts that are rephrased by the generation model 14 based on one initial draft of a notification text. The revised draft display column 127 displays each revised draft and displays the prediction result of an index indicating reactions from a user in a case in which the notification including the text of the revised draft has been received. This allows the operator to determine whether the rephrased revised draft is satisfactory based on the prediction result. As a result, the operator selects an appropriate one from multiple revised drafts and uses the selected revised draft as a notification text.

When the operator determines that the revised draft generated by the generation model 14 is appropriate based on the prediction result provided by the prediction model 26 and then operates the select button 128, the selected revised draft is used as a notification text. The above-described configuration also allows the operator to modify the selected revised draft as necessary. Then, when the operator operates the delivery button 135, the processor 21 sends, to one or more user terminal 60, a notification related to the corresponding notification record. As a result, the notification including the selected revised draft as a notification text is sent to the user terminal 60.

The generation model 14 may be a general-purpose language model. This eliminates the need for a dedicated learning model to generate a notification text. Thus, even when a notification category or advertising content is changed, the intended notification is generated simply by altering a prompt.

### Advantages of Present Disclosure

The present disclosure has the following advantages.
(1) The generation model 14 modifies the initial draft of a notification text so as to generate a revised draft of the notification text. Further, the prediction model 26 outputs the prediction result of an index indicating user reaction to the revised draft, allowing the operator to determine whether the revised draft generated by the generation model 14 is appropriate. Thus, the information processing system 11, the information processing method, and the non-transitory computer-readable medium storing the program according to the present disclosure enables the use of a machine learning model (particularly, the generation model 14) with a further improved approach.
(2) The generation model 14 generates multiple revised drafts for one initial draft simply by altering a modification instruction included in a prompt. Further, the prediction model 26 outputs multiple prediction results for each of the revised drafts using the same determination criteria. This allows the operator to readily determine which one of multiple revised drafts is appropriate.
(3) The processor 21 of the information processing device 20 sends multiple revised drafts and multiple prediction results to the terminal devices 80. This allows the operator to create a notification text using the terminal device 80 used by him.
(4) The operator selects one of multiple revised drafts as a notification text that is to be sent and modifies the selected revised draft. Then, the information processing device 20 sends a notification including the notification text to one or more user terminals 60. The inclusion of a modified notification text in a notification text in this manner improves user engagement with the notification. Further, the prediction model 26 is re-trained based on actual result data for the notification delivered in this manner, and the re-trained prediction model 26 is used to evaluate a revised draft. This enables continuous improvement in user engagement.
(5) One of multiple revised drafts that has the best prediction result of the prediction model 26 is displayed in the revised draft display column 127 of the terminal device 80. This eliminates the need for the operator to select one of the revised drafts.
(6) The modification instruction includes the store information for a store that places an advertisement. This allows the generation model 14 to generate a revised draft of the advertising text that is suitable for the advertisement of the store.
(7) The modification instruction includes supplementary information used to generate an advertising text. This allows the generation model 14 to generate a more suitable revised draft corresponding to the supplementary information. For example, when the supplementary information includes information indicating that the store placing the advertisement is affiliated with an electronic payment service and information indicating that the user who receives a notification uses the electronic payment service, the generation model 14 generates a revised draft suitable for the user of the electronic payment service.
(8) The notification display screen 75 displays an advertising text included in a notification of an electronic payment application (i.e., a pay app). This enables effective display of advertisements from merchants affiliated with the electronic payment service to its users.
(9) The prediction model 26 that outputs a prediction result corresponding to a user attribute is used. This allows the information processing device 20 to provide the operator with a suitable prediction result for each user. As a result, the operator selects a revised draft suitable for the attribute of a user to whom a notification is delivered.
(10) For the input revised draft, the prediction model 26 outputs a prediction value for an advertisement index indicating user engagement. This allows the operator to select, as a notification text, a revised draft that improves user engagement.
(11) The prediction model 26 outputs a prediction value for a click-through rate to the input revised draft. This allows the operator to select, as a notification text, a revised draft that improves a click-through rate.
(12) When the modification instruction includes an instruction for modifying one initial draft so as to improve an index value, the generation model 14 generates a revised draft that improves the prediction result of the prediction model 26.
(13) When the modification instruction includes an instruction for modifying one initial draft such that the index value approaches or exceeds a specified target value, the generation model 14 generates a more appropriate revised draft.

The present embodiment may be modified as described below. The present embodiment and the following modifications can be combined if the combined modifications remain technically consistent with each other.

### Modification of Generation Model

The generation model 14 may be configured to output, not only when receiving a prompt that includes a text but also when receiving a prompt that includes an initial image and a modification instruction for modifying the initial image, a revised image that is obtained by modifying the initial image in accordance with the modification instruction. This generation model 14 acquires a modified advertisement image in addition to the title and body text of an advertisement. Instead, the information processing system 11 may include a generation model 14 that serves as a language model to generate the text of a revised draft and another generation model suitable for generating an image.

In this case, the information processing device 20 may include a prediction model configured to output, when receiving one image example, the prediction result of an index indicating user reaction in a case in which the one image example has been received. The information processing device 20 acquires the prediction result for the revised image that has been output by the prediction model.

### First Modification of Prediction Model

The information processing system 11 may include multiple prediction models 26, each configured to output the prediction result of a different index. For example, the information processing device 20 may include a first prediction model that outputs a prediction value of a click-through rate (i.e., a first prediction result) and a second prediction model that outputs a prediction value of GMS (i.e., a second prediction result). In this case, the revised draft display column 127 may display at least one of the first prediction result or the second prediction result.

### Second Modification of Prediction Model

While the prediction model 26 does not have to predict an advertisement index, the prediction model 26 preferably predicts an index indicating user engagement with a notification. For example, if the notification is related to a new feature of the application, the number of times the feature is used or its usage rate may be employed. If the notification is a request prompting the user to perform an update, the execution rate of the update operation may be used.

### Modification of Modification Instruction

The modification instruction included in a prompt may include an objective that is different from that of the prediction index of the prediction model 26. For example, if the prediction index is a click-through rate, the objective included in the modification instruction may be to increase the number of visitors to the target store, increase the number of installations of the pay app, or increase traffic to the linked webpage.

### Modification of Notification Generating Method

Instead of an initial draft used for modification, the modification instruction may include a generating instruction for causing the generation model 14 to generate a new revised draft. That is, the generation model 14 may generate a new revised draft of a notification instead of modifying an initial draft from a requester. In this case, step S11 simply needs to be omitted, and step S12 simply needs to be changed to the sending of a generating request for a revised draft. When the generation model 14 generates a new revised draft, the prompt may or may not include one or more text examples for a notification text to be generated.

### First Modification of Application

The drafting tool may be installed in the information processing device 20 in advance. This allows the operator to use the drafting tool by operating the information processing device 20.

### Second Modification of Application

The drafting tool may be a native app installed and used on the terminal device 80 or may be a web application that runs on a web browser.

### Third Modification of Application

The drafting tool may include a function to display a prediction result of the prediction model 26 for an initial draft that has been input by an operator. In this case, upon receiving the initial draft, the information processing device 20 sends the prediction result for the revised draft and the prediction result for the initial draft to the terminal device 80. The terminal device 80 may display the prediction result received from the information processing device 20 in, for example, the body text input column 125. This modification allows the operator to determine whether the initial draft should be replaced with the revised draft by comparing between the prediction result for the revised draft and the prediction result for the initial draft.

### Modification of Notification

The notification text is not limited to being displayed via an app on the user terminal 60, and may be included in any type of electronic medium (e.g., email, chat, or web-based advertisements). The notification text may be printed on physical media (e.g., paper).

### Modification of Flowcharts and Diagrams

The flowcharts and diagrams in the present disclosure illustrate the device, system, method, program architecture, functionality, and operation of the embodiment in accordance with the present disclosure. The steps included in the flowcharts and the elements included in the diagrams may correspond to a part of a program including one or more commands for implementing a logical functional unit. Also, in the modifications, some of the illustrated steps may be omitted, other steps may be included, the steps may be in a different order, and some of the steps may be performed simultaneously. Further, the series of actions illustrated in the flowcharts may be divided into multiple parts when executed. Multiple flowcharts may be executed continuously or in association with one another. Furthermore, in the modifications, some of the illustrated components may be omitted, other components may be included, and the layout of the components may be changed. Additionally, functionalities implemented by such steps and element may be implemented by hardware, software, or a combination of hardware and software.

### Modification of Information Processing System

The information processing system 11 may be a single information processing device 20 (e.g., a computer) or may be distributed across multiple devices (e.g., computers) or subsystems that cooperate with each other to execute programs.

### Modification of Server

When the information processing system 11 includes multiple servers 30, each server 30 may include a database related to the service provided by that server 30. These databases may be configured to be linked with each other based on one or more shared data items or a shared identifier (a user ID in the case of a user database). When multiple user databases are used, the databases may be configured to be linked with each other based on one or more shared data items (e.g., the user's name and date of birth) or a shared user ID. Examples of the servers 30 may include, but are not limited to, a web server that provides an e-commerce site, a processing server that provides electronic payment services, and a management server that provides a point program.

### Modification of Memory

Each of the memories 22, 32, 42, 52, 62, and 82 of the devices according to the present disclosure is a computer-readable storage medium and includes a non-transitory computer-readable medium. Examples of the memory include, but are not limited to, a ROM, a hard disk, storage, a removable medium, flash memory, a memory stick, an optical medium, a magneto-optical medium, and a CD-ROM.

### Modification of Processor

Examples of one or more processors 21, 31, 41, 51, 61, and 81 included in the devices according to the present disclosure include, but are not limited to, a central processing unit (CPU), a graphics processing unit (GPU), an accelerated processing unit (APU), a neural network processing unit (NPU), a microprocessor, a microcontroller, a digital signal processor (DSP), a field-programmable gate array (FPGA), a complex programmable logic device (CPLD), another type of processor such as a general-purpose processor, an application-specific integrated circuit (ASIC), or any combination thereof configured to execute the functions described in this specification.

### Modification of Network

Communication between multiple devices or systems may be performed via one or more communication networks in accordance with known communication protocols. Examples of the communication network include, but are not limited to, an intranet, the Internet, a local area network, a wide area network, a wireless network, a wired network, a virtual network, a software-defined network, any other type of network, or any combination thereof.

### Modification of Communication IF

The communication IFs 23, 33, 43, 53, 63, and 83 provide a function in which one device communicates with other devices via a communication network. Examples of the communication IF 23 may include, but are not limited to a local area network (LAN), Wi-Fi®, Bluetooth®, or any other wireless communication IF.

The technical ideas understood from the above-described embodiment and the modifications are as follows.
[Clause 1] An information processing system, including:
   a memory that stores commands; and
   at least one processor, where
   the at least one processor executes the commands to perform:
      inputting a prompt into a generation model for machine learning, where the generation model is configured to output, when receiving an instruction for generating data, the data generated in accordance with the instruction, and the prompt includes one initial draft of a notification text to be sent to one or more user terminals and includes a modification instruction for modifying the one initial draft;
      acquiring, from the generation model, a revised draft obtained by the generation model by modifying the one initial draft in accordance with the modification instruction;
      inputting the revised draft into a prediction model for machine learning, where the prediction model is configured to output, when receiving the revised draft, a prediction result for an index indicating response from a user in a case in which the revised draft has been received; and
      acquiring the prediction result for the revised draft that has been output by the prediction model.
[Clause 2] The information processing system according to clause 1, where
   the modification instruction includes an instruction for generating multiple revised drafts for the one initial draft, and
   the at least one processor is configured to execute:
      acquiring, from the generation model, multiple revised drafts generated by the generation model in accordance with the modification instruction;
      inputting the revised drafts into the prediction model; and
      acquiring multiple prediction results for each of the revised drafts that have been output by the prediction model.
[Clause 3] The information processing system according to clause 2, where
   the at least one processor executes is configured to send, to a terminal device used by an operator responsible for creating the notification text, the revised drafts and the prediction results for each of the revised drafts.
[Clause 4] The information processing system according to clause 2 or 3, where
   the at least one processor executes is configured to send a notification to the one or more user terminals, and
   the notification includes, as the notification text, one of the revised drafts that has been selected by the operator or includes, as the notification text, a text obtained by the operator by modifying the one revised draft.
[Clause 5] The information processing system according to any one of clauses 2 to 4, where
   the at least one processor is configured to display, on a terminal device used by an operator responsible for creating the notification text, one of the revised drafts that has the best prediction result.
[Clause 6] The information processing system according to any one of clauses 1 to 5, where
   the notification text includes an advertising text for one store,
   the at least one processor is configured to acquire store information for the one store, and
   the modification instruction includes the store information for the one store.
[Clause 7] The information processing system according to any one of clauses 1 to 6, where
   the notification text includes an advertising text for one store,
   the modification instruction includes supplementary information used to generate the advertising text, and
   the supplementary information includes information indicating that the one store is affiliated with an electronic payment service and information indicating that the user uses the electronic payment service.
[Clause 8] The information processing system according to any one of clauses 1 to 7, where
   the at least one processor is configured to send, to the one or more user terminals, a notification including the notification text, where the notification is generated using a format that is to be displayed on an application installed on each of the one or more user terminals,
   the format includes a title and a body text of the notification, and
   the revised draft is at least part of the title or the body text.
[Clause 9] The information processing system according to any one of clauses 1 to 8, where
   the prediction model is configured to output a prediction result that corresponds to an attribute of a user after being trained using user data for multiple users, where the user data include multiple attribute values for each of the users, and
   the at least one processor is configured to execute:
      inputting, into the prediction model, the revised draft and an attribute of a user who is to receive the notification text; and
      acquiring the prediction result corresponding to the attribute of the user that has been output by the prediction model.
[Clause 10] The information processing system according to any one of clauses 1 to 9, where
   the index indicates user engagement.
[Clause 11] The information processing system according to any one of clauses 1 to 10, where
   the at least one processor is configured to send, to the one or more user terminals, a notification that includes the notification text,
   the notification includes a link to a website, and
   the index is a click-through rate.
[Clause 12] The information processing system according to any one of clauses 1 to 11, where
   the modification instruction includes an instruction for modifying the one initial draft so as to improve a value of the index.
[Clause 13] The information processing system according to any one of clauses 1 to 12, where
   the modification instruction includes an instruction for modifying the one initial draft such that a value of the index approaches or exceeds a specified target value.
[Clause 14] An information processing method executed by one or more processors, the information processing method including:
   inputting a prompt into a generation model for machine learning, where the generation model is configured to output, when receiving an instruction for generating data, the data generated in accordance with the instruction, and the prompt includes one initial draft of a notification text to be sent to one or more user terminals and includes a modification instruction for modifying the one initial draft;
   acquiring, from the generation model, a revised draft obtained by the generation model by modifying the one initial draft in accordance with the modification instruction; and
   inputting the revised draft into a prediction model for machine learning, where the prediction model is configured to output, when receiving the revised draft, a prediction result for an index indicating response from a user in a case in which the revised draft has been received.
[Clause 15] A program for causing at least one processor to execute:
   inputting a prompt into a generation model for machine learning, where the generation model is configured to output, when receiving an instruction for generating data, the data generated in accordance with the instruction, and the prompt includes one initial draft of a notification text to be sent to one or more user terminals and includes a modification instruction for modifying the one initial draft;
   acquiring, from the generation model, a revised draft obtained by the generation model by modifying the one initial draft in accordance with the modification instruction; and
   inputting the revised draft into a prediction model for machine learning, where the prediction model is configured to output, when receiving the revised draft, a prediction result for an index indicating response from a user in a case in which the revised draft has been received.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

1. An information processing system, comprising:
one or more memories configured to store program code; and
one or more processors, wherein
the one or more processors are configured to read the program code and operate as instructed by the program code, and
the program code comprises:
prompt code configured to cause at least one of the one or more processors to input a prompt into a generation model for machine learning, wherein the generation model is configured to output, when receiving an instruction for generating data, the data generated in accordance with the instruction, and the prompt includes one initial draft of a notification text to be sent to one or more user terminals and includes a modification instruction for modifying the one initial draft;
revision code configured to cause at least one of the one or more processors to acquire, from the generation model, at least one revised draft obtained by the generation model by modifying the one initial draft in accordance with the modification instruction;
prediction code configured to cause at least one of the one or more processors to input the at least one revised draft into a prediction model for machine learning, wherein the prediction model is configured to output, when receiving the at least one revised draft, a prediction result for at least one index indicating response from a user in a case in which a corresponding revised draft has been received; and
result code configured to cause at least one of the one or more processors to acquire the prediction result that has been output by the prediction model.

2. The information processing system according to claim 1, wherein
the modification instruction includes an instruction for generating multiple revised drafts for the one initial draft,
the revision code is configured to cause at least one of the one or more processors to acquire, from the generation model, multiple revised drafts generated by the generation model in accordance with the modification instruction,
the prediction code is configured to cause at least one of the one or more processors to input the revised drafts into the prediction model, and
the result code is configured to cause at least one of the one or more processors to acquire multiple prediction results for each of the revised drafts that have been output by the prediction model.

3. The information processing system according to claim 2, wherein
the program code further comprises sending code configured to cause at least one of the one or more processors to send, to a terminal device used by an operator responsible for creating the notification text, the revised drafts and the prediction results for each of the revised drafts.

4. The information processing system according to claim 3, wherein
the program code further comprises notification code configured to cause at least one of the one or more processors to send a notification to the one or more user terminals, and
the notification includes, as the notification text, one of the revised drafts that has been selected by the operator or includes, as the notification text, a text obtained by the operator by modifying the one revised draft.

5. The information processing system according to claim 2, wherein
the program code further comprises displaying code configured to cause at least one of the one or more processors to display, on a terminal device used by an operator responsible for creating the notification text, one of the revised drafts that has the best prediction result.

6. The information processing system according to claim 1, wherein
the notification text includes an advertising text for one store,
the program code further comprises store code configured to cause at least one of the one or more processors to acquire store information for the one store, and
the modification instruction includes the store information for the one store.

7. The information processing system according to claim 1, wherein
the notification text includes an advertising text for one store,
the modification instruction includes supplementary information used to generate the advertising text, and
the supplementary information includes information indicating that the one store is affiliated with an electronic payment service and information indicating that the user uses the electronic payment service.

8. The information processing system according to claim 1, wherein
the program code further comprises notification code configured to cause at least one of the one or more processors to send, to the one or more user terminals, a notification including the notification text, wherein the notification is generated using a format that is to be displayed on an application installed on each of the one or more user terminals,
the format includes a title and a body text of the notification, and
the revised draft is at least part of the title or the body text.

9. The information processing system according to claim 1, wherein
the prediction model is configured to output a prediction result that corresponds to an attribute of a user after being trained using user data for multiple users, wherein the user data include multiple attribute values for each of the users,
the prediction code is configured to cause at least one of the one or more processors to input, into the prediction model, the revised draft and an attribute of a user who is to receive the notification text, and
the result code is configured to cause at least one of the one or more processors to acquire the prediction result corresponding to the attribute of the user that has been output by the prediction model.

10. The information processing system according to claim 1, wherein
the index indicates user engagement.

11. The information processing system according to claim 1, wherein
the program code further comprises notification code configured to cause at least one of the one or more processors to send, to the one or more user terminals, a notification that includes the notification text,
the notification includes a link to a website, and
the index is a click-through rate.

12. The information processing system according to claim 1, wherein
the modification instruction includes an instruction for modifying the one initial draft so as to improve a value of the index.

13. The information processing system according to claim 1, wherein
the modification instruction includes an instruction for modifying the one initial draft such that a value of the index approaches or exceeds a specified target value.

14. An information processing method executed by one or more processors, the information processing method comprising:
inputting a prompt into a generation model for machine learning, wherein the generation model is configured to output, when receiving an instruction for generating data, the data generated in accordance with the instruction, and the prompt includes one initial draft of a notification text to be sent to one or more user terminals and includes a modification instruction for modifying the one initial draft;
acquiring, from the generation model, at least one revised draft obtained by the generation model by modifying the one initial draft in accordance with the modification instruction;
inputting the at least one revised draft into a prediction model for machine learning, wherein the prediction model is configured to output, when receiving the at least one revised draft, a prediction result for at least one index indicating response from a user in a case in which a corresponding revised draft has been received; and
acquiring the prediction result that has been output by the prediction model.

15. A non-transitory computer-readable medium storing a program, the program comprising:
prompt code configured to cause at least one of the one or more processors to input a prompt into a generation model for machine learning, wherein the generation model is configured to output, when receiving an instruction for generating data, the data generated in accordance with the instruction, and the prompt includes one initial draft of a notification text to be sent to one or more user terminals and includes a modification instruction for modifying the one initial draft;
revision code configured to cause at least one of the one or more processors to acquire, from the generation model, at least one revised draft obtained by the generation model by modifying the one initial draft in accordance with the modification instruction;
prediction code configured to cause at least one of the one or more processors to input the at least one revised draft into a prediction model for machine learning, wherein the prediction model is configured to output, when receiving the at least one revised draft, a prediction result for at least one index indicating response from a user in a case in which a corresponding revised draft has been received; and
result code configured to cause at least one of the one or more processors to acquire the prediction result that has been output by the prediction model.
